(19) United States
(12) Patent Application Publication
(10) Pub. No.: US 2022/0197923 A1
(43) Pub. Date: Jun. 23, 2022

(54) APPARATUS AND METHOD FOR BUILDING BIG DATA ON UNSTRUCTURED CYBER THREAT INFORMATION AND METHOD FOR ANALYZING UNSTRUCTURED CYBER THREAT INFORMATION

(71) Applicant: ELECTRONICS AND TELECOMMUNICATIONS RESEARCH INSTITUTE, Daejeon (KR)

(72) Inventors: Gae-Ock JEONG, Daejeon (KR); Woo-Young GO, Daejeon (KR); Seung-Jin RYU, Daejeon (KR); Sung-Ryoul LEE, Daejeon (KR); Han-Jun YOON, Daejeon (KR); Woo-Ho LEE, Daejeon (KR)

(21) Appl. No.: 17/557,821

(22) Filed: Dec. 21, 2021

(30) Foreign Application Priority Data
Dec. 23, 2020 (KR) 10-2020-0182297

(51) Int. Cl. G06F 16/25; G06F 21/55; G06N 3/08

(52) U.S. Cl. CPC G06F 16/258; G06N 3/08; G06F 21/554

(57) ABSTRACT

Disclosed herein are an apparatus and method for constructing big data on unstructured cyber threat information. The method may include collecting unstructured cyber threat information, structuring the collected unstructured cyber threat information based on a previously trained AI model, and constructing big data from the structured cyber threat information.

### CROSS REFERENCE TO RELATED APPLICATION

This application claims the benefit of Korean Patent Application No. 10-2020-0182297, filed Dec. 23, 2020, which is hereby incorporated by reference in its entirety into this application.

### BACKGROUND OF THE INVENTION

### 1. Technical Field

The disclosed embodiment relates to technology for constructing big data by extracting cyber threat information based on 5W1H through natural-language-processing technology using Artificial Intelligence (AI) and for automatically connecting pieces of data in the big data and inferring the association therebetween.

### 2. Description of Related Art

The cyberworld, which is globally connected with the development of the Internet, has grown as broad as the real world. Accordingly, cyberattack methods are also being developed day by day, and more sophisticated and large-scale cyberattacks are occurring. Cyberattacks cause serious damage, and the extent of such damage is increasing.

However, cyber defense technology for defending against automated and sophisticated cyberattacks is lagging behind them. Particularly, the number of cybersecurity incident analysts for responding to cyber threats is limited. Further, compared to the automation level of attack tools, automation technology for cyber threat response and analysis tools used for incident analysis or malware analysis faces many challenges due to technical limitations. In order to overcome such limitations, continuous attempts to solve cyber threat analysis problems by merging the expertise of cybersecurity incident analysts with AI have recently been made.

With regard to cybersecurity incidents, cyber threat information in a structured form, such as vulnerability information or malware characteristics, is widely shared, but there is also information that is simply and quickly spread through short pieces of textual information, such as news, blogs, or tweets. Also, various cyber intelligence services provided for the purpose of warning about and responding to cyber threats are present, but major global information security companies charge a subscription fee for their services. As described above, various forms of cyber threat information are present, but because most cyberattacks occur very locally for a limited time, it is impossible to immediately collect all information related thereto. Also, for international political, social, or military reasons, information about specific cyberattacks related to some cyber threats may not be shared. In spite of these various limitations, efforts to collect a large amount of various kinds of cyber threat information and analyze the same from the aspect of big data are underway in industry and academia.

Among various kinds of cyber threat information, cyber threat information in a structured form, such as vulnerability information and malware characteristics, is present, but intelligence reports, malware analysis reports, or vulnerability analysis reports based on precise investigation and analysis of cyber threats after actual cybersecurity incidents are generally written in unstructured natural language and provided in that form.

Such threat analysis reports are written in a natural language by experts so have an unstructured form, which makes it difficult for computing systems to automate analysis of the threat analysis reports.

### SUMMARY OF THE INVENTION

An object of the disclosed embodiment is to achieve automated construction of big data on cyber threat information by automatically collecting cyber threat information in an unstructured form and structuring the same using AI technology, thereby overcoming limitations imposed due to the lack of cyber threat analysts.

Another object of the disclosed embodiment is to enable proactive detection of new unknown cybersecurity threats based on an AI model trained based on constructed big data on cyber threat information.

A method for constructing big data on unstructured cyber threat information according to an embodiment may include collecting unstructured cyber threat information written in a natural language, structuring the collected unstructured cyber threat information based on an AI model, and constructing big data from the structured cyber threat information.

Here, structuring the collected unstructured cyber threat information may include performing embedding by quantifying (vectorizing) the unstructured cyber threat information using a security language model based on AI; and extracting 5W1H-based metadata from an embedded natural language based on a named-entity recognition model.

Here, the security language model may be generated in advance by collecting unstructured training data, creating the security language model as an AI neural network, converting the collected unstructured training data to a data format of input to the security language model, and training the created security language model using the converted unstructured training data.

Here, creating the security language model may comprise creating the security language model based on at least one of a Masked Language Model (MLM), trained to guess an arbitrary blank word in an input sentence, and Next Sentence Prediction (NSP), trained to determine whether two input sentences are consecutive sentences.

Here, the security language model may be created based on Bidirectional Encoder Representations from Transformers (BERT).

Here, the named-entity recognition model may be generated in advance by constructing training data labeled with metadata by a security expert from the unstructured cyber threat information and training the named-entity recognition model, which uses a result of security language model embedding, using the constructed training data.

A method for analyzing association of cyber threat information according to an embodiment may include constructing a cyber threat knowledge graph based on big data on cyber threat information; and learning the constructed cyber threat knowledge graph based on AI and inferring cyber threat information using a trained model.

Here, constructing the cyber threat knowledge graph may include extracting cyber threat report metadata from constructed big data on cyber threat information, redefining entities and a relationship in a form of a triple, including a head, a relation, and a tail, through integration and selection of the extracted metadata, and converting the defined triple to a data set for a knowledge graph representation.

Here, constructing the cyber threat knowledge graph may further include verifying the triple through ontology visualization analysis of the triple of the cyber threat information.

Here, inferring the cyber threat information may include generating a learning model for quantifying a relationship between pieces of previously collected cyber threat information through AI-based modeling based on a knowledge graph and analyzing and inferring a relationship between pieces of new cyber threat information based on the generated learning model.

Here, the AI-based modeling may be performed based on Graph Neural Networks (GNN) configured to quantify each entity and a relationship of the knowledge graph in a vector form.

An apparatus for constructing big data on unstructured cyber threat information according to an embodiment includes memory in which at least one program is recorded and a processor for executing the program. The program may perform collecting unstructured cyber threat information, structuring the collected unstructured cyber threat information based on an AI model trained in advance, and constructing big data from the structured cyber threat information.

Here, structuring the collected unstructured cyber threat information may include performing embedding by quantifying (vectorizing) the unstructured cyber threat information using a security language model based on AI and extracting 5W1H-based metadata from an embedded natural language based on a named-entity recognition model.

Here, the security language model may be generated in advance by collecting unstructured training data, creating the security language model as an AI neural network, converting the collected unstructured training data to a data format of input to the security language model, and training the security language model using the converted unstructured training data.

Here, creating the security language model may comprise creating the security language model based on at least one of a Masked Language Model (MLM), trained to guess an arbitrary blank word in an input sentence, and Next Sentence Prediction (NSP), trained to determine whether two input sentences are consecutive sentences.

Here, the security language model may be created based on Bidirectional Encoder Representations from Transformers (BERT).

Here, the named-entity recognition model may be generated in advance by constructing training data labeled with metadata by a cyber security expert from the unstructured cyber threat information and training the named-entity recognition model, which uses a result of security language model embedding, using the constructed training data.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a flowchart for explaining a method for constructing big data on cyber threat information and analyzing associations therein according to an embodiment;

FIG. 2 is a schematic block diagram of a system for performing a method for constructing big data on cyber threat information according to an embodiment;

FIGS. 3 and 4 are flowcharts for explaining a method for constructing big data on cyber threat information according to an embodiment;

FIG. 5 is a structural diagram of a named-entity recognition model for security based on a security language model for extracting cyber threat information according to an embodiment;

FIG. 6 is an exemplary view illustrating extraction of security text semantics according to an embodiment;

FIG. 7 is a schematic block diagram of a system for performing a method for analyzing the association between pieces of cyber threat information according to an embodiment;

FIG. 8 is a flowchart for explaining a method for analyzing the association between pieces of cyber threat information according to an embodiment;

FIG. 9 is a flowchart for explaining construction of a knowledge graph according to an embodiment; and

FIG. 10 is a view illustrating a computer system configuration according to an embodiment.

### DESCRIPTION OF THE PREFERRED EMBODIMENTS

The advantages and features of the present invention and methods of achieving the same will be apparent from the exemplary embodiments to be described below in more detail with reference to the accompanying drawings. However, it should be noted that the present invention is not limited to the following exemplary embodiments, and may be implemented in various forms. Accordingly, the exemplary embodiments are provided only to disclose the present invention and to let those skilled in the art know the category of the present invention, and the present invention is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present invention.

The terms used herein are for the purpose of describing particular embodiments only, and are not intended to limit the present invention. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

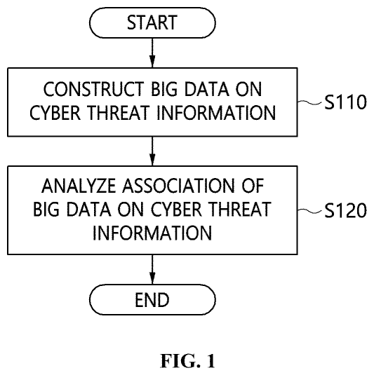

Hereinafter, an apparatus and method according to an embodiment will be described in detail with reference to FIGS. 1 to 9.

FIG. 1 is a flowchart for explaining a method for constructing big data on cyber threat information and analyzing association according to an embodiment.

Referring to FIG. 1, an embodiment may include constructing big data on cyber threat information at step S110 and automatically connecting pieces of data in the constructed big data and analyzing associations therebetween at step S120.

Here, constructing the big data on cyber threat information at step S110 may comprise automatically collecting a large amount of various kinds of cyber threat information having a structured/unstructured form and structuring unstructured data, among the collected data, using AI technology, thereby constructing big data on cyber threat information based on 5W1H (Who, What, When, Where, Why, and How).

To this end, an AI language model optimized for computers to recognize natural-language data in a security field is generated, which has not been attempted before in a cybersecurity field, and cyber threat information may be automatically structured based on the generated AI language model.

Here, analyzing the association at step 120 may comprise defining relationships between entities of the big data on the structured cyber threat information, automatically constructing a cyber threat knowledge graph based on the defined relationships, and developing technology for providing the constructed relationship information so as to show the relationships between cyber threats.

To this end, multiple triple formats for representing the relationship between the entities are defined, and data matching with triple format is automatically recognized and stored in a graph database according to an embodiment. Also, all of the pieces of structured cyber threat data are connected and schematized using a multi-dimensional graph such that the association therebetween is able to be tracked.

Furthermore, through AI learning of the graph data constructed according to an embodiment, the association may be tracked based on multi-dimensional data connection, which enables information that is unknown and left blank in a 5W1H form to be inferred from similar existing pieces of cyber threat information, or enables a specific element of newly added cyber threat information organized in a 5W1H form to be inferred and predicted. Accordingly, experts' efforts to analyze cyber threats may be saved.

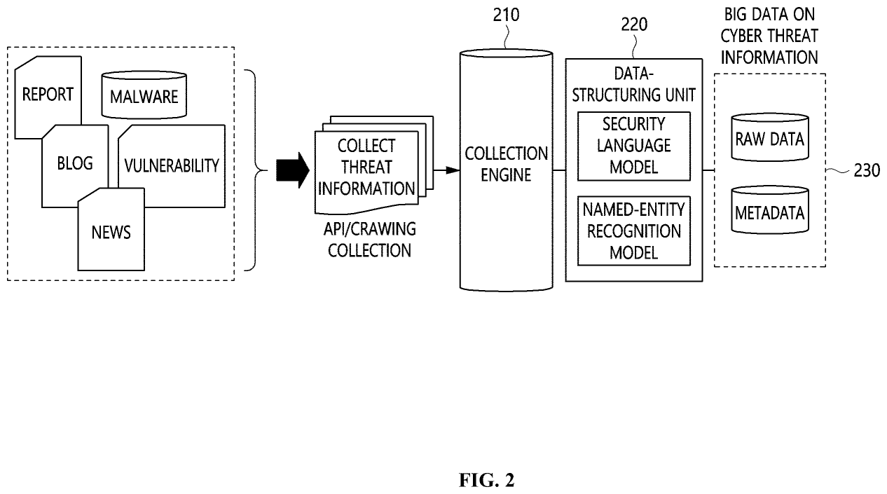

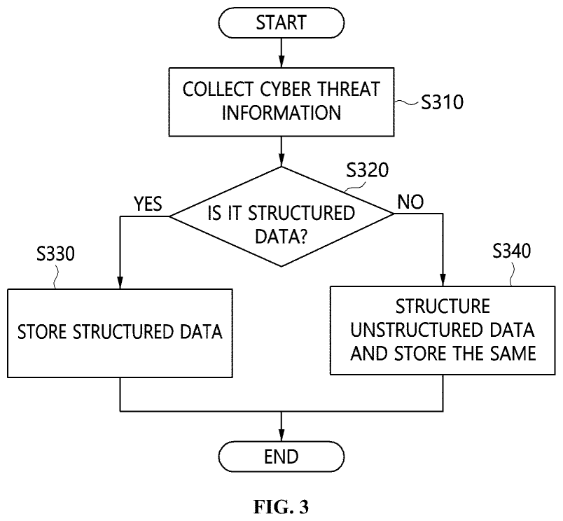

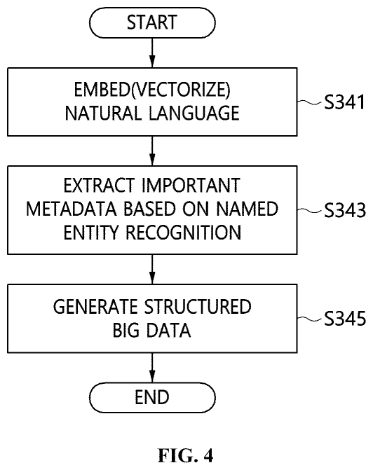

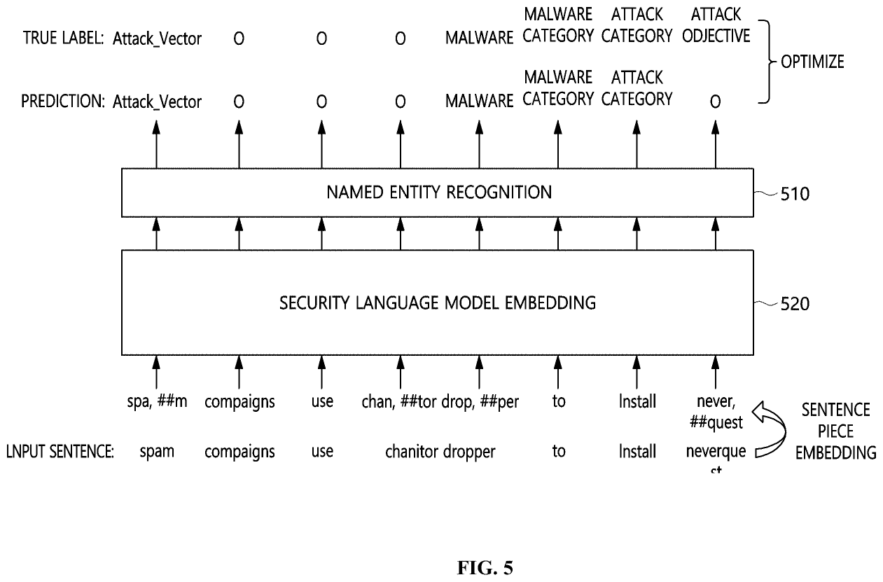

FIG. 2 is a schematic block diagram of a system for performing a method for constructing big data on cyber threat information according to an embodiment, FIGS. 3 and 4 are flowcharts for explaining a method for constructing big data on cyber threat information according to an embodiment, FIG. 5 is a structural diagram of a named-entity recognition model for security based on a security language model for extracting cyber threat information according to an embodiment, and FIG. 6 is an exemplary view illustrating extraction of security text semantics according to an embodiment.

Referring to FIG. 2 and FIG. 3, a collection engine 210 collects cyber threat information at step S310.

Here, the collection engine 210 may collect data from Internet sites that provide cyber-threat-related information, which is classified in advance by experts, through website crawling.

Here, when the collected cyber threat information is text data, it may be stored immediately. Here, the text data may be, for example, ASCII text and HTML.

However, when the collected cyber threat information is binary data, only text data may be extracted therefrom using a predetermined program, and the extracted text data may be stored. Here, the binary data may be data acquired by storing text in an encoded format, for example, a PDF, HWP, or DOC file format, through a special process.

Also, the collected cyber threat information may be unstructured data, and may include reports written in unstructured natural language, such as a cyber threat analysis report, a malware analysis report, and a vulnerability analysis report, and short sentences related to cyber threats, such as news, blogs, Twitter tweets, and the like.

Also, the collected cyber threat information may be structured data, and may include published vulnerability information (CVE) provided by MITRE and collected malware information.

Subsequently, a data-structuring unit 220 may classify the collected cyber threat information into structured data and unstructured data based on a predetermined format at step S320.

Here, the unstructured data may be data written in a natural language, and the structured data may be data written in a predetermined format in a data provision source.

When it is determined at step S320 that the collected cyber threat information is structured data, the data-structuring unit 220 may store the same in a predetermined big data storage format at step S330.

Here, the predetermined structured data storage format may be a table form in which the names of metadata extracted from the cyber threat information and a description thereof are stored after being classified according to classification criteria based on 5W1H. Examples of the predetermined storage formats of the structured data are listed in Table 1 and Table 2 below.

In Table 1, the characteristic information (metadata) of vulnerability data and descriptions thereof are listed.

TABLE 1

| classification | metadata name | description of metadata |
|---|---|---|
| How | CVE_ID | unique identification number of CVE |
| | CWE | Common Weakness Enumeration name/ID |
| | ProblemType | vulnerability attack type |
| | cvss3_BaseScore | CVSS v3.0 vulnerability assessment score |
| | cvss3_Vector | vector string for CVSS v3.0 assessment metric |
| | cvss3_ImpactScore | CVSS v3.0 impact score |
| | cvss3_ExploitScore | CVSS v3.0 exploitability score |
| | cvss_BaseScore | CVSS v2.0 vulnerability assessment score |
| | cvss_Vector | vector string for CVSS v2.0 assessment metric |
| | cvss_ImpactScore | CVSS v2.0 impact score |
| | cvss_ExploitScore | CVSS v2.0 exploitability score |
| What | Affect_Vendors | name of vendor of product in which vulnerability |
| | | is found |
| | Affect_Products | OS or name of product in which vulnerability is |
| | | found |
| | Affect_ProductVer | version information of product in which |
| | | vulnerability is found |
| When | publishedDate | date and time when vulnerability information was |
| | | published |
| | lastModifiedDate | last modified date of vulnerability information |
| N/A | DataType | vulnerability data type |
| | DataFormat | vulnerability data format |
| | DataVersion | vulnerability data version |
| | CVE_Assigner | information about organization requesting |
| | | assignment or allocation of corresponding CVE |
| | CVE_State | status of CVE registration |
| | Description | description of vulnerability |
| | ref_URL | link to reference data related to vulnerability |
| | ref_Source | provider of reference data related to vulnerability |
| | ref_Name | name of reference data related to vulnerability |

In Table 2, the characteristic information (metadata) of malware data and descriptions thereof are listed.

TABLE 2

| classification | metadata name | description of metadata |
|---|---|---|
| How | NickName | alias and nickname of malware |
| | Hash_MD5 | unique MD5 hash value specifying malware |
| | Hash_SHA1 | unique SHA1 hash value specifying malware |
| | Hash_SHA256 | unique SHA256 hash value specifying malware |
| | CVE | CVE number list related to malware |
| When | publishedDateTime | date and time when malware information is |
| | | published |
| | FirstSeenDateTime | date and time when malware is first |
| | | discovered/detected or date and time when |
| | | malware file is collected |
| N/A | PositiveCount | number of times file is determined to be malware |
| | | when checked using multiple types of vaccine |
| | | software |
| | Filetype | file format |
| | Filesize | file size (byte) |
| | Taglist | tag name of malware file and related tag list |
| | Imphash | import-table-based hash value of PE type file |
| | Ssdeep | ssdeep-based hash value of file |
| | Source | source (site name) from which malware |
| | | information is provided |

Conversely, when it is determined at step S320 that the cyber threat information is not structured data, the data-structuring unit 220 stores the unstructured data after structuring the same at step S340.

Examples of the predetermined storage formats for the unstructured data are listed in Table 3 and Table 4 below.

In Table 3, the characteristic information (metadata) of tweet data and descriptions thereof are listed.

TABLE 3

| classification | metadata name | description of metadata |
|---|---|---|
| N/A | usernameTweet | tweet user name (Tweeter ID) |
| | text | content of tweet text |
| | datetime | date and time when tweet is posted |
| | medias | address of link to relevant media |

Here, the data-structuring unit 220 automatically extracts characteristic information (metadata) like what is listed in Table 4 below from an analysis report based on 5W1H including “who”, “when”, “where”, “what”, “why”, and “how”, thereby structuring the information.

TABLE 4

| classification | metadata name | description of metadata |
|---|---|---|
| Who | Threat_Actor | name of attacker, attack group (APT group, etc.) |
| When | Time_Attack | start time of actual attack |
| | Time_referenced | time when attack-related content is first mentioned |
| Where | Attack_Nation | attack start region (nation): nation known to be |
| | | start point of attack |
| | Attack_Region | attack start region (city): region or city of nation |
| | | known to be start point of attack |
| | IP_Attack | list of attacker's IP addresses contained in report |
| | IP_Waypoint | list of IP addresses used/passed through by |
| | | attacker, which is contained in report |
| | Domain_Attack | list of attacker's URLs contained in report |
| | Domain_Waypoint | list of URLs used/passed through for attack, which |
| | | is contained in report |
| what | Victim_Nation | victim nation: nation in which victim is located |
| | Victim_Region | victim region: region or city of nation in which |
| | | victim is located |
| | Victim_Target | victim organization name: name of company or |
| | | organization of victims |
| | Victim_product | name of OS or product that is target of attack |
| | Target_Industry | type of industry of victim: name of industry type |
| | | classification of victim (North America Industry |
| | | Classification System (NAICS) code number) |
| | IP_Target | list of victim's or victim system's IP addresses |
| | | contained in report |
| | Domain_Target | list of victim's or victim system's URLs contained |
| | | in report |
| How | Attack_Vector | list of attack methods including categories of |
| | | industry standard (128 categories of Recorded |
| | | Future, 12 categories of CVE, 314 categories of |
| | | MITRE, etc.) |
| | Attack_tool | program or tool used for attack |
| | CVE_Numbers | CVE number: CVE number list related to report |
| | Vulnerability | vulnerability identification number other than |
| | | CVE number (CWE, MS, TSL ID, etc.) |
| | Malware | list of names of malware related to report |
| | Hash_MD5 | MD5 hash value of malware mentioned in report |
| | Hash_SHA1 | SHA1 hash value of malware mentioned in report |
| | Hash_SHA256 | SHA256 hash value of malware mentioned in |
| | | report |
| | Severity_Score | score list indicating severity of attack and |
| | | vulnerability (CVSS, TSL score/severity, etc.) |
| | Email_Address | email address used for attack |
| Why | Attack_Objective | objective of corresponding cyberattack |

Here, referring to FIG. 2, when structuring the unstructured data and storing the same at step S340 is performed, the data-structuring unit 220 may structure the unstructured data based on a security language model and a named-entity recognition model.

That is, referring to FIG. 4, the data-structuring unit 220 embeds (vectorizes) a natural language of the unstructured cyber threat information based on a security language model at step S341.

Here, the security language model may be developed to specialize in the security field based on Google's Bidirectional Encoder Representations from Transformers (BERT) technology, which currently exhibits the best performance in natural language processing, in order to meet the demand for development of security-field natural-language-processing technology for automatically extracting semantics of cyber-threat-related security data.

Here, embedding indicates transforming a language into a vector capable of being understood by AI.

Here, BERT is high-performance sentence-embedding technology developed by Google. However, Google's BERT is trained using general data, so performance may decrease when it is used for sentences and language in a special field. Therefore, BERT for special fields, such as SciBERT and BioBERT, rather than general BERT, may be developed for science and biotechnology fields. However, this is an example, and the present invention is not limited to BERT. That is, the use of various other models, including BART, MASS, and ELECTRA, used in a natural-language-processing field, may be included in the scope of the present invention.

Such a security language model may be a model that is generated in advance by collecting unstructured training data, creating a security language model as an AI neural network, converting the collected unstructured training data into the data format for input to the security language model, and training the created security language model using the converted unstructured training data.

Here, when collecting the unstructured training data is performed, security-related data, such as cyber security papers, reports, blogs, news, and the like, may be collected through parsing, preprocessing, and filtering processes.

Here, when converting the collected unstructured training data is performed, preprocessing, by which security-related data, such as cyber security papers, reports, blogs, news, and the like, is converted so as to be suitable for the input to the security language model based on BERT, may be performed.

Here, when creating the security language model is performed, the security language model may be created to learn MLM and NSP problems in order to sufficiently include the semantic and grammatical information of a security natural language.

Here, a Masked Language Model (MLM) is configured such that training is performed to guess an arbitrary hidden word in an input sentence, and Next Sentence Prediction (NSP) is configured such that training is performed to determine whether two input sentences are consecutive sentences.

When training using 110 million parameters was actually performed 4000 times over two months, it could be seen that training of a security language model was completed with 99.4% accuracy on NSP and 92.2% accuracy on MLM.

Referring again to FIG. 4, the data-structuring unit 220 extracts 5W1H-based metadata from the recognized natural language based on a named-entity recognition model at step S343.

The named-entity recognition model automatically extracts important metadata without reading a security document, thereby enabling semantics to be grasped.

Here, named-entity recognition may be prediction of an entity, for example, a nation, a person, or the like, to which a word in a sentence corresponds based on AI.

Such a named-entity recognition model may be a model generated in advance by constructing training data labeled with metadata by a cyber security expert from unstructured cyber threat information and by training a named-entity recognition model, which uses the result of security language model embedding, using the constructed training data.

Here, when constructing the training data is performed, after a large number of security reports (provided from FireEye, Kaspersky, Symantec, Trend Micro, and Recorded Future) (e.g., 1000 reports) is selected, cyber security experts perform metadata labeling in consideration of context while reading the security reports, and the labeled data is converted to a CoNLL2003 format, which is most commonly used for named entity recognition, whereby actual security named-entity recognition data may be generated.

Here, when training the named-entity recognition model is performed, the security language model 520 is used as embeddings, and the named-entity recognition model 510 is configured as BiLSTM+CRF, whereby transfer learning may be performed, as illustrated in FIG. 5.

Here, BiLSTM+CRF may be the deep-learning-based model structure exhibiting the best performance in the field of named entity recognition.

Here, transfer learning is a learning method that reuses a previously trained model, and exhibits good performance when there is a lack of data.

That is, when transfer learning is performed based on a security language model, performance is improved, as shown in the experimental result of Table 5 below.

TABLE 5

| | number of | | | | F1 |
|---|---|---|---|---|---|
| | parameters | training time | loss | accuracy | score |
| train only named-entity | 95,356 | 7 hr. 4 min. | 0.400 | 83.8 | 62.9 |
| recognition model (excluding | | | | | |
| security language model) | | | | | |
| train both security language | 109,577,596 | 7 hr. 13 min. | 0.008 | 89.6 | 77.5 |
| model and named-entity | | | | | |
| recognition model | | | | | |

Meanwhile, a sub-word used for the input of each security language model may be embedded in 768 dimensions through the security named-entity recognition model.

Also, 124 labels may be generated by applying BIOES indexing to the metadata listed in Table 4.

Also, the named-entity recognition model 510 may be trained to select the most suitable label, among 124 labels, for each sub-word.

That is, referring to FIG. 6, the named-entity recognition model 510 may match each word included in the input sentence 610 with the most suitable label 620, and may collect the labels for each piece of metadata (630).

Also, the named-entity recognition model 510 may be designed as a shallow layer neural network having 768-dimensional input and 124-dimensional output.

Also, when, for example, 9000 labeled sentences in 300 reports are used, 90% of the data may be used for training and 10% thereof may be used for testing.

Through the above-described method for constructing big data on cyber threat information, 5W1H-based important data on cyber threat information, which is acquired by automatically structuring unstructured data, such as reports, tweets, news, and the like, using AI, may be stored in the cyber threat information big data system 230 illustrated in FIG. 2, and various types of data collected from various collection sources, such as malware, vulnerabilities, and the like, which are structured data, may also be stored therein after being filtered based on 5W1H depending on the data source or the data format.

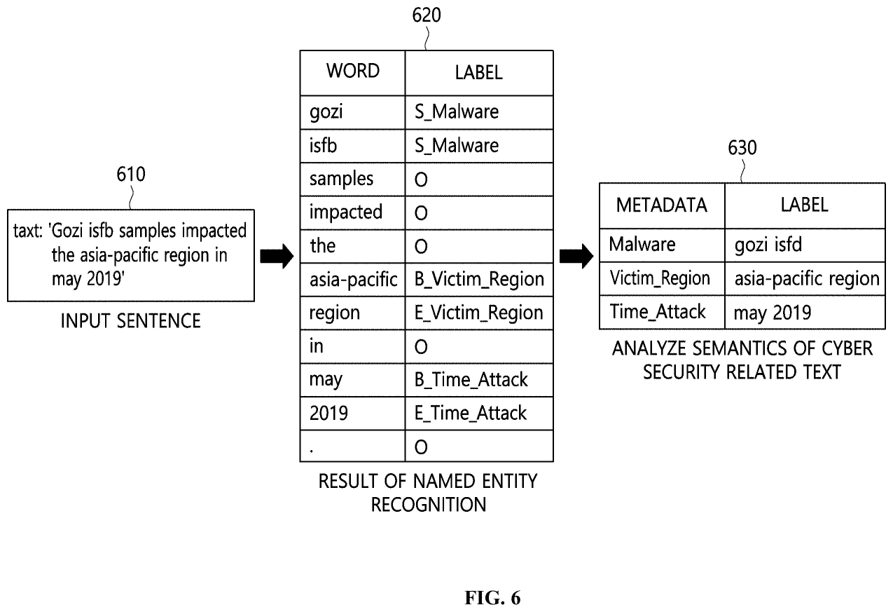

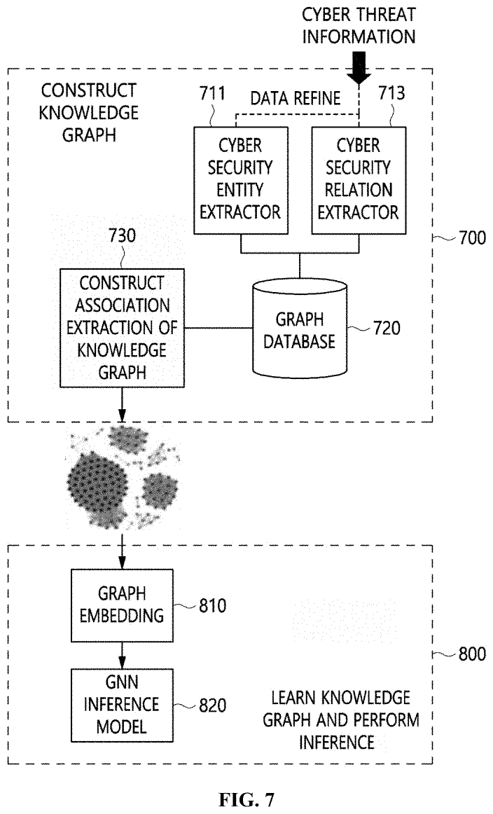

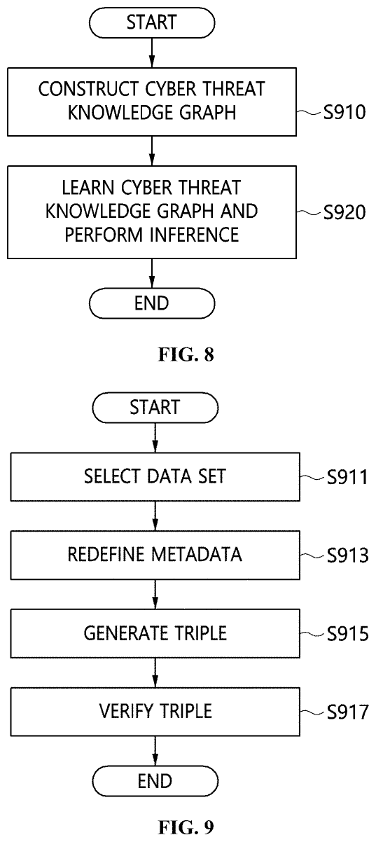

FIG. 7 is a schematic block diagram of a system for performing a method for analyzing the association between pieces of cyber threat information according to an embodiment, FIG. 8 is a flowchart for explaining a method for analyzing the association between pieces of cyber threat information according to an embodiment, and FIG. 9 is a flowchart for explaining construction of a knowledge graph according to an embodiment.

Referring to FIG. 8, the method for analyzing the association between pieces of cyber threat information according to an embodiment may include constructing a cyber threat knowledge graph based on big data on cyber threat information at step S910 (performed by the component denoted by reference number 700 in FIG. 7) and performing AI-based training based on the constructed cyber threat knowledge graph and inferring cyber threat information based on the trained model at step S920 (performed by the component denoted by reference number 700 in FIG. 7).

Here, when constructing the cyber threat knowledge graph is performed at step S910, a knowledge graph suitable for a security field is designed in order to analyze the association and relationship between multiple types of structured cyber threat information. Accordingly, a search of high-level relationships and main information relationships may be schematized and provided based on the knowledge graph.

Referring to FIG. 9, constructing the cyber threat knowledge graph at step S910 may include extracting cyber threat report metadata from the constructed big data on cyber threat information at step S911 (performed by the components denoted by reference numbers 711 and 713 in FIG. 7), redefining entities and relationships in a triple format including a head, a relation, and a tail through integration and selection of the extracted metadata at step S913 (performed by the components denoted by reference numbers 711 and 713 in FIG. 7), and converting the defined triple format into a data set for a knowledge graph representation at step S915 (performed by the component denoted by reference number 730 in FIG. 7).

When redefining the entities and the relationships is performed at step S913 according to an embodiment, 12 entities and 6 relationships may be defined through integration and selection of the extracted metadata.

Here, examples of the entities may include Attack_Objective, Victim_Location, Victim_Target, IP, Domain, Email, CVE, Threat_Actor, Malware, Attack_Vector, and Attack_Tool.

Here, examples of the relationships may include Include, Use, Relate, Attack, Target, and Exploit.

When converting the defined triple is performed at step S915 according to an embodiment, a triple of the selected metadata may be defined and converted into an RDF dataset using Rdflib.

Here, after heuristic analysis on the relationships between the selected pieces of metadata, a triple for the relationship between an attack nation and a victim nation, a tool used for an attack, and the like may be defined.

Here, a triple is a data structure for knowledge graph learning, and defines component entities and a relationship using <head, relation, tail>. An example thereof may be as shown in Table 6.

TABLE 6
Triple(Head, relation, tail)

Attack_Nation, Attack(exploit), Victim_Nation
Attack_Tool, using, Threat_actor
Attack_Tool, target, Victim_Nation
Victim_Nation, has, Victim_Target
Threat_actor, using, CVE
Victim_Nation, related, CVE
Attack_Tool, include, report
Attack_Tool, made, Attack_Nation

Here, a Resource Description Framework (RDF) is a standard defined by W3C in order to represent information about resources on a web, and may be used to represent a knowledge graph.

Here, Rdflib is a Python library for representing information between pieces of unstructured metadata in an RDF triple structure.

Constructing the cyber threat knowledge graph at step S910 according to an embodiment may further include verifying the triple through ontology visualization analysis of the triple of the cyber threat information at step S917 (performed by the component denoted by reference number 730 in FIG. 7).

Meanwhile, inferring the cyber threat information at step S920 may include generating a learning model for quantifying the relationship between previously collected pieces of cyber threat information through AI-based modeling based on the knowledge graph (performed by the component denoted by reference number 810 in FIG. 7) and analyzing and inferring the relationship between pieces of new cyber threat information based on the generated learning model (performed by the component denoted by reference number 820 in FIG. 7).

Here, AI-based modeling, that is, Knowledge Graph Embedding (KGE), may be performed based on Graph Neural Networks (GNN), which quantify each entity and relationship in a knowledge graph in a vector form.

Here, the cyber threat information triple data set is divided into a training set, a verification set, and a test set at a ratio of 90:5:5, whereby KGE model training may be performed.

For example, KGE may be performed using 1440 pieces of training data for the three kinds of triples.

Then, entity and relationship embedding model training may be performed using a TransE 12 model or a DistMult model.

Here, the TransE 12 model or the DistMult model may be an AI model that induces similar types of entities to be connected to be close to each other and induces entities that are not similar to each other to be distant in a low-dimensional embedding space.

Meanwhile, after a triple set for a test is constructed for a performance test of the trained model, triple sorting performance evaluation may be performed.

Here, the performance of inference as to whether two entities have a new relationship therebetween (the relationship between an attack and a nation, and the like) may be evaluated.

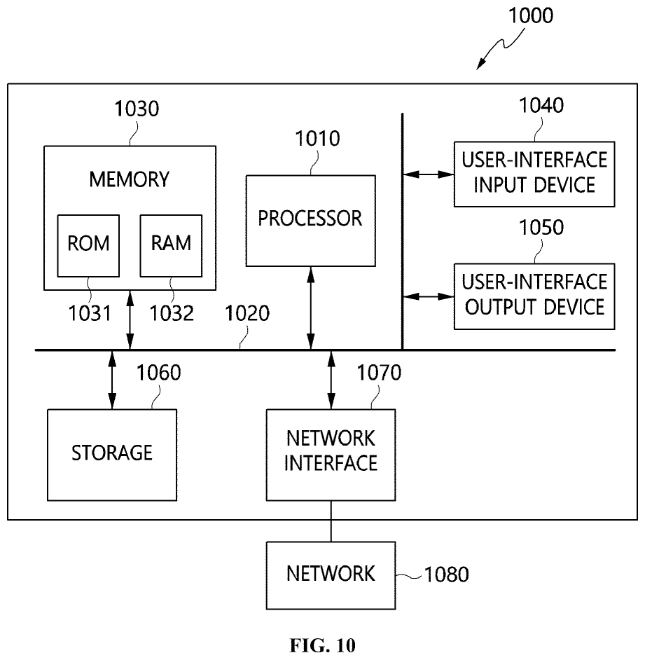

FIG. 10 is a view illustrating a computer system configuration according to an embodiment.

The apparatus for constructing big data on unstructured cyber threat information according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected to a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, and an information delivery medium. For example, the memory 1030 may include ROM 1031 or RAM 1032.

According to an embodiment, automated collection and classification of a large amount of various kinds of cyber-threat-related data may be achieved using AI, whereby limitations imposed due to the lack of cyber threat analysts may be overcome.

According to an embodiment, insights into undiscovered cyber threats may be provided by systematically organizing existing cyber threats and extracting an association therebetween, whereby technology capable of responding to cyber threats may be provided.

Although embodiments of the present invention have been described with reference to the accompanying drawings, those skilled in the art will appreciate that the present invention may be practiced in other specific forms without changing the technical spirit or essential features of the present invention. Therefore, the embodiments described above are illustrative in all aspects and should not be understood as limiting the present invention.

What is claimed is:

1. A method for constructing big data on unstructured cyber threat information, comprising:
collecting unstructured cyber threat information written in a natural language;
structuring the collected unstructured cyber threat information based on an AI model trained in advance; and
constructing big data from the structured cyber threat information.

2. The method of claim 1, wherein the structuring of the collected unstructured cyber threat information includes:
performing embedding by quantifying (vectorizing) the unstructured cyber threat information using a security language model based on AI; and
extracting 5W1H-based metadata from an embedded natural language based on a named-entity recognition model.

3. The method of claim 2, wherein the security language model is generated in advance by:
collecting unstructured training data;
creating the security language model as an AI neural network;
converting the collected unstructured training data to a data format of input to the security language model; and
training the created security language model using the converted unstructured training data.

4. The method of claim 3, wherein the creating of the security language model comprises:
creating the security language model based on at least one of a Masked Language Model (MLM), trained to guess an arbitrary blank word in an input sentence, and Next Sentence Prediction (NSP), trained to determine whether two input sentences are consecutive sentences.

5. The method of claim 3, wherein the named-entity recognition model is generated in advance by:
constructing training data labeled with metadata by a cyber security expert from the unstructured cyber threat information; and
training the named-entity recognition model, which uses a result of security language model embedding, using the constructed training data.

6. A method for analyzing association of cyber threat information, comprising:
constructing a cyber threat knowledge graph based on big data on cyber threat information; and
learning the constructed cyber threat knowledge graph based on AI and inferring cyber threat information using a trained model.

7. The method of claim 6, wherein the constructing of the cyber threat knowledge graph includes:
extracting cyber threat report metadata from constructed big data on cyber threat information;
redefining entities and a relationship in a form of a triple, including a head, a relation, and a tail, through integration and selection of the extracted metadata; and
converting the defined triple to a data set for a knowledge graph representation.

8. The method of claim 7, further comprising:
verifying the triple through ontology visualization analysis of the triple of the cyber threat information.

9. The method of claim 6, wherein the inferring of the cyber threat information includes:
generating a learning model for quantifying a relationship between pieces of previously collected cyber threat information through AI-based modeling based on a knowledge graph; and
analyzing and inferring a relationship between pieces of new cyber threat information based on the generated learning model.

10. The method of claim 9, wherein the AI-based modeling is performed based on Graph Neural Networks (GNN) configured to quantify each entity and a relationship of the knowledge graph in a vector form.

11. An apparatus for constructing big data on unstructured cyber threat information, comprising:
memory in which at least one program is recorded; and
a processor for executing the program,
wherein the program performs:
collecting unstructured cyber threat information written in a natural language;
structuring the collected unstructured cyber threat information based on an AI model trained in advance; and
constructing big data from the structured cyber threat information.

12. The apparatus of claim 11, wherein the structuring of the collected unstructured cyber threat information includes:
performing embedding by quantifying (vectorizing) the unstructured cyber threat information using a security language model based on AI; and
extracting 5W1H-based metadata from an embedded natural language based on a named-entity recognition model.

13. The apparatus of claim 12, wherein the security language model is generated in advance by:
collecting unstructured training data;
creating the security language model as an AI neural network;
converting the collected unstructured training data to a data format of input to the security language model; and
training the created security language model using the converted unstructured training data.

14. The apparatus of claim 13, wherein the creating of the security language model comprises:
creating the security language model based on at least one of a Masked Language Model (MLM), trained to guess an arbitrary blank word in an input sentence, and Next Sentence Prediction (NSP), trained to determine whether two input sentences are consecutive sentences.

15. The apparatus of claim 13, wherein the named-entity recognition model is generated in advance by:
constructing training data labeled with metadata by a cyber security expert from the unstructured cyber threat information; and
training the named-entity recognition model, which uses a result of security language model embedding, using the constructed training data.
